(19) United States
(12) Patent Application Publication
(10) Pub. No.: US 2004/0173677 A1
(43) Pub. Date: Sep. 9, 2004

(54) Integrated circuit and magnetic stripe reader

(76) Inventors: Bennie E. Lucas, Long Beach, CA (US); Justin F. McJones, Rancho Palos Verdes, CA (US); Jerry W. Parsons, Long Beach, CA (US); Kevin Tayeban, Los Angeles, CA (US)

Correspondence Address: CHRISTIE, PARKER & HALE, LLP, P.O. BOX 7068, PASADENA, CA, 91109-7068, US

(21) Appl. No.: 10/383,393

(22) Filed: Mar. 7, 2003

(51) Int. Cl. G06K 7/00

(52) U.S. Cl. 235/440

(57) ABSTRACT

Methods and apparatus are described for reading data from either a magnetic stripe, a chip or both a magnetic stripe and a chip located on a data card using a single swiping motion. An advantage of the methods and apparatus described is that movement of a data card is detected, restrained and/or prevented during exchange of information between the reader and any integrated circuits located on the data card. One embodiment of the invention includes guiding walls leading to a receiver having an interior surface, a magnetic reading head mounted on one of the guiding walls and electrical contacts located on the interior surface of the receiver. In addition, the receiver is configured to resist the removal of the data card when the data card is located within the receiver.

### BACKGROUND OF THE INVENTION

The present invention relates generally to data card readers. More specifically, the invention relates to card readers capable of reading data from either a magnetic stripe or an integrated circuit located on a card or both.

Magnetic stripe cards are a form of data card that has become ubiquitous as a means of transporting, presenting and preserving data. The many uses for magnetic stripe cards include credit cards, debit cards, security cards and tickets. Typically, data is encoded on the magnetic stripe and this data is used to facilitate a transaction between the cardholder and an electronic device. Magnetic stripe cards can be susceptible to fraud, however. Often, reproduction of the information stored on a magnetic stripe card is sufficient to enable an imposter to transact as if he or she possessed the actual magnetic stripe card.

In certain applications, the use of a data card bearing an integrated circuit (“chip card”) can provide increased security. In order to minimize disruption caused by the introduction of chip cards into an environment where magnetic stripe cards are already in use, it is desirable for a single device to read magnetic stripe cards, chip cards and hybrid magnetic stripe/chip cards. Magnetic stripe card readers often receive data from magnetic stripe cards by the user swiping a card through a slot containing a magnetic reading head. The inconvenience to merchants caused by the introduction of a new reader can be reduced by providing a device capable of reading data from magnetic stripe cards, chip cards and hybrid magnetic stripe/chip cards using a swiping action cardholders are familiar with due to their use of conventional magnetic stripe card readers.

One difficulty with designing such a new swipe reader is that movement of a chip card while it is in communication with the reader can result in system failure. Therefore, a challenge in constructing a multi-function swipe reader has been limiting the movement of the cards while they communicate with the reader.

### SUMMARY OF THE INVENTION

Embodiments of the present invention can provide an improved method of reading data from magnetic stripe cards, chip cards and hybrid magnetic stripe/chip cards using a single swiping motion similar to the swiping motion employed in conventional magnetic stripe card readers. Several embodiments of the invention include the advantage of constraining the motion of a data card while the reader and an integrated circuit mounted on the card communicate. Other embodiments of the invention include the advantages of detecting motion of the data card while the reader and an integrated circuit mounted on the card communicate.

One embodiment that reads data from a data card possessing an integrated circuit and/or a magnetic stripe includes guiding walls leading to a receiver having an interior surface, a magnetic reading head mounted on one of the guiding walls and electrical contacts located on the interior surface of the receiver. In addition, the receiver is configured to resist the removal of the data card when the data card is located within the receiver.

In another embodiment, the receiver includes a base, a rear wall and side walls and the side walls are configured to provide an entrance to the receiver. In an alternative embodiment, the receiver also includes a top wall and the base, rear wall, side walls and top wall are configured to prevent all motion of the data card except removal of the data card from the receiver entrance.

In a further embodiment, the receiver also includes a pivotally mounted arm that is configured to resist removal of the data card from the receiver entrance. In yet another embodiment, the receiver also includes at least one clip that is configured to resist removal of the data card from the receiver entrance.

In a further embodiment again, the interior surface of the receiver is configured to contact the surface of the data card when the data card is within the receiver and friction between the interior surface and the data card resists removal of the data card from the receiver entrance. In another form of the receiver, the interior surface of the receiver contains compressible features.

Another alternative embodiment includes a movable latch, where the latch is configured to allow insertion of the data card when the latch occupies a first position and to resist removal of the data card when the latch occupies a second position. In some instances the latch can be spring loaded. In another further embodiment, the side walls are configured to form an opening in the top of the receiver. The receiver may also include at least one clip that is configured to resist removal of the data card from the opening in the top of the receiver. Additionally, the interior surface of the receiver can also be configured to contact the surface of the data card, when the data card is within the receiver, such that friction between the interior surface and the data card resists removal of the data card from the opening in the top of the receiver.

Yet another alternative embodiment includes rollers mounted in the side walls of the receiver, where the rollers are configured to rotate as the data card is inserted into the receiver through the receiver entrance and where friction between the surface of the rollers and the data card resists removal of the data card from the opening in the top of the receiver.

A still further alternative embodiment has side walls and guiding walls that form a curved transition at the receiver entrance, where the curved transition is configured to reduce the likelihood of an edge of the data card catching against one of the side walls of the receiver during insertion of the data card into the receiver. In addition, the side walls may also flare outwards at the entrance to the receiver.

Still another embodiment includes a magnetic reading head mounted on a guiding wall and a receiver connected to the guiding wall that contains electrical contacts configured to communicate with an integrated circuit located on a data card. In another form, the invention includes a sensor configured to detect movement of a card inserted into the receiver. In this embodiment, the receiver is configured to resist all motion of the data card when the electrical contacts communicate with the integrated circuit located on the data card. A further alternative embodiment again includes means for guiding the magnetic stripe on the data card past a magnetic reading head and means for resisting movement of the data card in all directions during the reading of data from the integrated circuit located on the data card.

The method of the invention includes moving the magnetic stripe relative to a magnetic reading head, applying forces to the card that resist motion of the card and reading data from the card while the forces that resist motion of the card are applied to the card.

### BRIEF DESCRIPTION OF THE DRAWINGS

FIG. 1 is an isometric view illustrating one side of a card reader constructed in accordance with the present invention including a magnetic reading head that can read information recorded on magnetic stripes and electrical contacts capable of communicating with an integrated circuit;

FIG. 2 is another isometric view of one opposite side of the card reader of FIG. 1, showing in greater detail the circuitry used to communicate with integrated circuits mounted on data cards;

FIG. 3 is a somewhat diagrammatic vertical cross-sectional view of the card reader of FIGS. 1 and 2 taken along the line 28 of FIG. 2 showing the use of retaining clips and a spring-loaded retaining arm to constrain the motion of a data card;

FIG. 4 is a vertical cross-sectional view similar to FIG. 3 showing another embodiment of a card reader in accordance with the present invention including a receiver with an interior surface that constrains the motion of a data card;

FIGS. 5A and 5B are horizontal cross-sectional views of the card reader of FIG. 4 taken along the line 48 of FIG. 4 showing the use of compressible materials to generate friction between the interior surface of a receiver and a data card;

FIG. 6 is a vertical cross-sectional view similar to FIG. 3 showing another embodiment of a card reader in accordance with the present invention including a receiver having an entrance, an additional opening and an interior surface configured to constrain the motion of a data card;

FIG. 7 is a vertical cross-sectional view similar to FIG. 3 of a further embodiment of a card reader in accordance with the present invention including retaining clips that constrain the motion of a data card;

FIG. 8 is a vertical cross-sectional view similar to FIG. 3 showing yet another embodiment of a card reader in accordance with the present invention including rollers that can constrain the motion of a data card;

FIG. 9 is a horizontal cross-sectional view of the card reader similar to the card reader of FIG. 8 taken along the line 84 showing elliptical rollers used to constrain the motion of a data card;

FIG. 10 is a cross sectional view similar to FIG. 9 showing an embodiment of a card reader in accordance with the present invention including rollers and a latch that constrain the motion of a data card;

FIG. 11 is a cross sectional view similar to FIG. 10 showing an embodiment of a card reader in accordance with the present invention including a spring loaded latch to constrain the motion of a data card; and

FIG. 12 is a cross sectional view similar to FIG. 4 showing an embodiment of a card reader in accordance with the present invention incorporating a sensor to detect card lift-out.

### DETAILED DESCRIPTION OF THE INVENTION

Referring to the drawings, a card reader 10 constructed in accordance with one embodiment of the present invention includes a card receiver 12 and card guiding walls 14 that extend outwardly from the entrance of the card receiver 16. The guiding walls form a channel to guide a card 18 past a magnetic reading head 20 and into the card receiver. As the card enters the receiver, contacts 22 within the receiver become aligned with specific locations on the card surface 24 where contacts connected to an integrated circuit (not shown) may be located. The mating of the two sets of contacts enables communication between the reader 10 and the integrated circuit to read and/or write information to the card. Once inside the receiver, the motion of the card is constrained to reduce the risk that the card will inadvertently move away from its intended location within the receiver while information is being exchanged between the reader 10 and the integrated circuit. In this way, the card reader enables data to be read from both a magnetic stripe and an integrated circuit located on a data card in a single swiping action. At the same time, the potential for communication between the reader and the data card to be interrupted due to movement of the data card is minimized. A variety of techniques can be used to prevent movement of the data card, a number of which are discussed below.

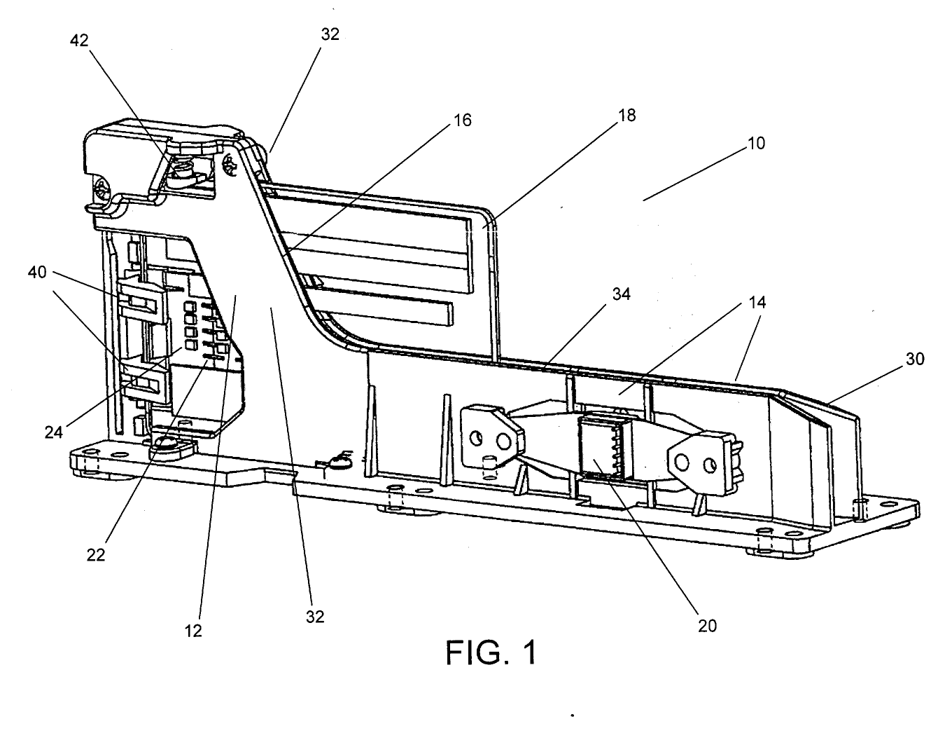

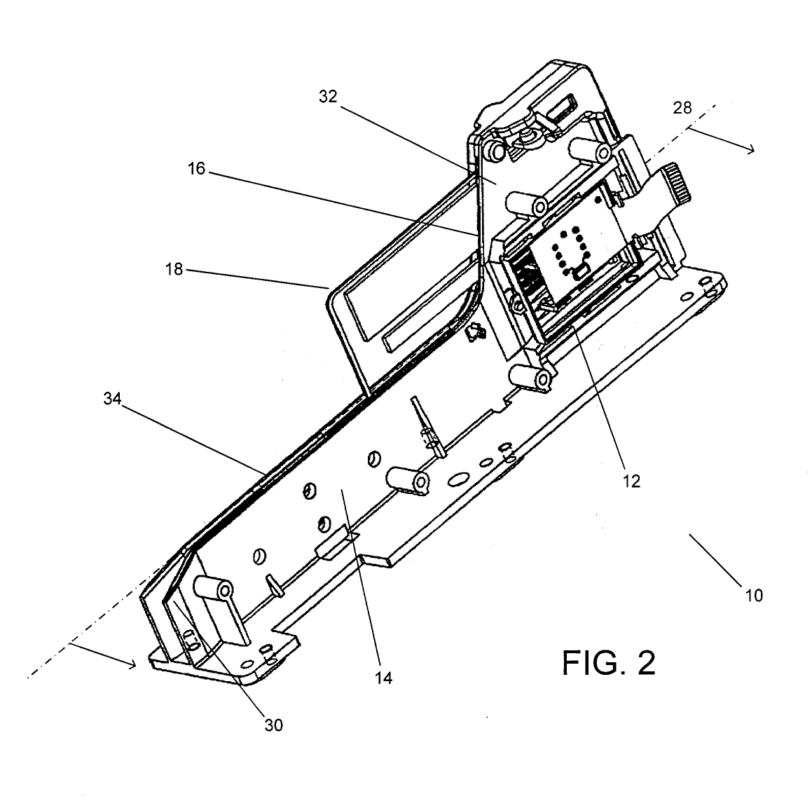

A card reader 10 in accordance with the present invention is illustrated in FIGS. 1-3. The card reader includes guiding walls 14 that are flared at one end 30 to guide a data card into a channel created by the guiding walls. The guiding walls guide the card to the receiver entrance 16. The receiver entrance is formed by two substantially parallel walls 32 referred to as the receiver side walls. The receiver side walls are cut to assist the guiding of the card into the receiver.

The shape of the receiver entrance 16 determines the ease with which a card is inserted into the receiver. If the receiver walls are constructed to form a right angle with the top edge 34 of the guiding walls, then a flexible data card can catch against one of the receiver walls during insertion. Providing a curved transition between the top edge of the guiding walls and the entrance reduces the likelihood that a card will catch as it is inserted into the receiver. An example of a suitable curved transition is shown in FIGS. 1-3. The extent of curvature required to prevent the card edge from catching on the walls of the receiver is dependent upon the width of the channel formed by the guiding walls and the flexibility of the cards read by the reader. Less curvature is required if the channel is narrower or the flexibility of the card is reduced. The likelihood of a card catching on a receiver side wall can also be reduced by flaring the receiver walls 32 at the receiver entrance 16. The flaring can guide the leading edge of a flexed card into the receiver.

A magnetic reading head 20 is mounted on one side of the channel formed by the card guiding walls 14. The magnetic reading head can be mounted to read information that is recorded on a magnetic stripe as a data card possessing a magnetic stripe is swiped past the magnetic reading head.

Contacts 22 for communicating with integrated circuits mounted on data cards are located on the inside of the receiver 12. In systems where ISO data cards are used, the contacts are mounted on the receiver side wall 32 opposite the guide wall 14 on which the magnetic reading head is attached. In other embodiments, multiple magnetic reading heads can be used and the location of the contacts within the receiver can be independent of the location of any of the magnetic reading heads.

The card receiver also includes a pivotably connected retaining arm 42, which is spring loaded. The receiver walls, the roof of the receiver 41 and the retaining arm act to substantially limit the motion of a card within the receiver. Once a card is inside the receiver, the card is free to move only in the direction required to withdraw the card from the receiver entrance. Downward pressure exerted by springs on the retaining arm acts to resist the removal of the card from the receiver entrance. By resisting the removal of the data card, the retaining arm prevents inadvertent movement that might otherwise break the contact between the reader and an integrated circuit of a data card while information is being exchanged via the contact. The receiver also includes a pair of card guides 40 that apply forces to the card that urge the contacts on the card against the contacts in the card reader, which increases the likelihood that an electrical connection is made when warped cards are inserted into the card reader. In other embodiments, the card guides can be replaced with mechanically or electronically activated retaining clips. In addition to urging the contacts of warped cards against the receiver contacts, retaining clips can provide additional resistance to the removal of the data card from the receiver. In one embodiment, the retaining clips are spring loaded and configured to grip the card in response to the triggering of a sensor and release the card following exchange of information between the integrated circuit on the card and the card reader. The loading on the clips can also be achieved using an electromechanical system such as an inductive coil that utilizes magnetic forces to move the retaining clips or an electrical motor to achieve the same function.

The embodiment shown in FIGS. 1-3 is configured to enable a user to swipe a data card past a magnetic reading head into a receiver that restricts the motion of the data card, which enables information to be reliably read from or written to an integrated circuit located on the card. Additional techniques can be used to limit the movement of a data card once it is inside the receiver.

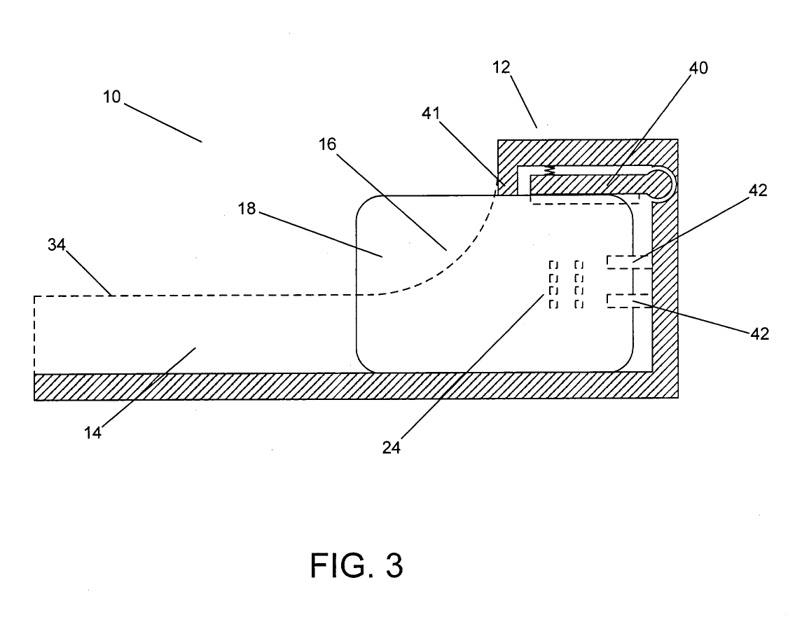

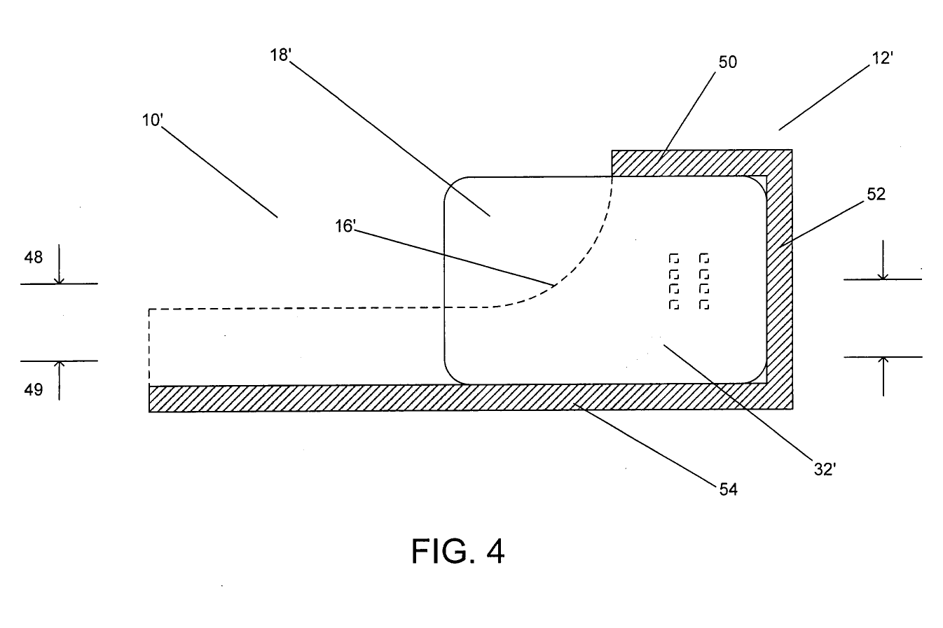

FIG. 4 illustrates a card reader 10′ in accordance with the present invention in a view similar to the cross section of FIG. 3. A data card 18′ is shown within the receiver 12′. The receiver includes a top wall 50, a rear wall 52, a base 54 and side walls 32′ that prevent all movement of the data card except removal of the data card from the receiver entrance 18′. Removal of the card from the receiver entrance is resisted by friction between the portions of the top wall, rear wall, base and side walls of the receiver that are in contact with the data card. The amount of friction that exists between the card and the interior surfaces of the receiver determines the magnitude of the force required to remove the card from the receiver.

A very small manufacturing tolerance is required to construct the card reader 10′ shown in FIG. 4 above so that the interior surface of the receiver 12′ contacts the data card and generates sufficient friction to prevent inadvertent movement of a data card once it has been inserted into the receiver. The required manufacturing tolerances can be increased by lining the interior surfaces of the receiver with a compressible material.

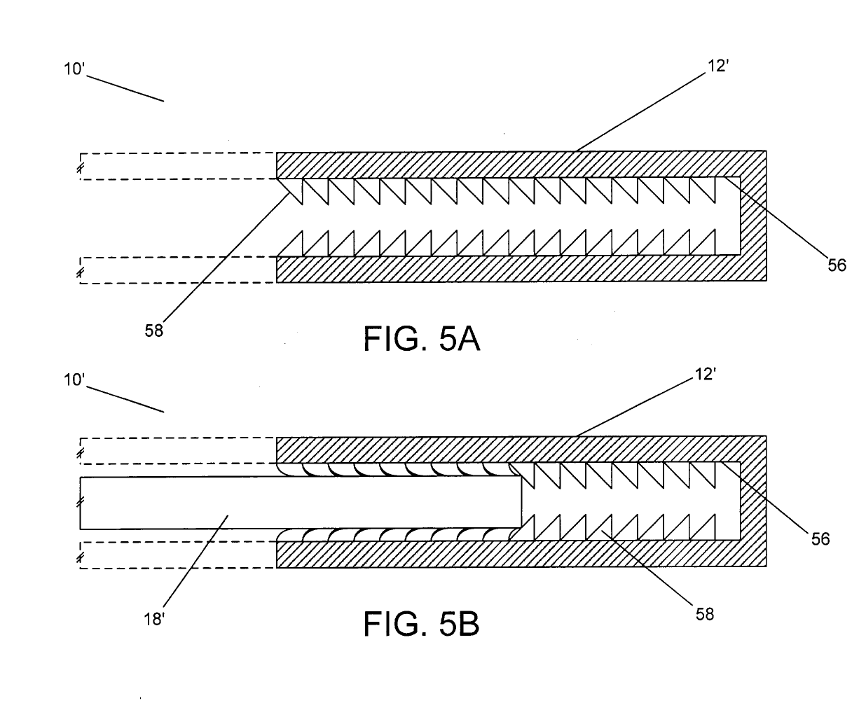

Cross sections of a card reader similar to that shown in FIG. 4 with an interior surface 56 constructed from a resilient compressible material that includes sawtooth features 58 are shown in FIGS. 5A and 5B. The cross-sections are taken along the line 48 defined in FIG. 4. As a data card pushes past each sawtooth feature, the feature is compressed, creating a large contact surface between the feature and the data card. Forcing the card further into the receiver increases the number of compressed sawtooth features in contact with the card and, therefore, increases the friction between the card and the interior surface of the receiver. Therefore, the force required to insert the card is initially small and increases as the card is inserted further inside the receiver. Once inside the receiver, the card is initially difficult to remove; however, less force is required the further the card is withdrawn from the reader. Although the illustrated embodiment shows the use of sawtooth features, any compressible features that create friction between the card surface and the interior surface of the receiver can be used.

The swiping action used by merchants operating conventional magnetic swipe card readers involves grasping the card and swiping it through the reader. The embodiments of card readers above use receivers that almost completely enclose data cards when they are inserted into the receiver. Therefore, care must be exercised in selecting the portion of the card to be clasped when swiping it through the reader. Embodiments of the present invention can be constructed so that a greater portion of a data card extends from the receiver, in which the card has been inserted. Such card readers enable a user to be less selective in choosing the portion of a data card to clasp when swiping it in the reader.

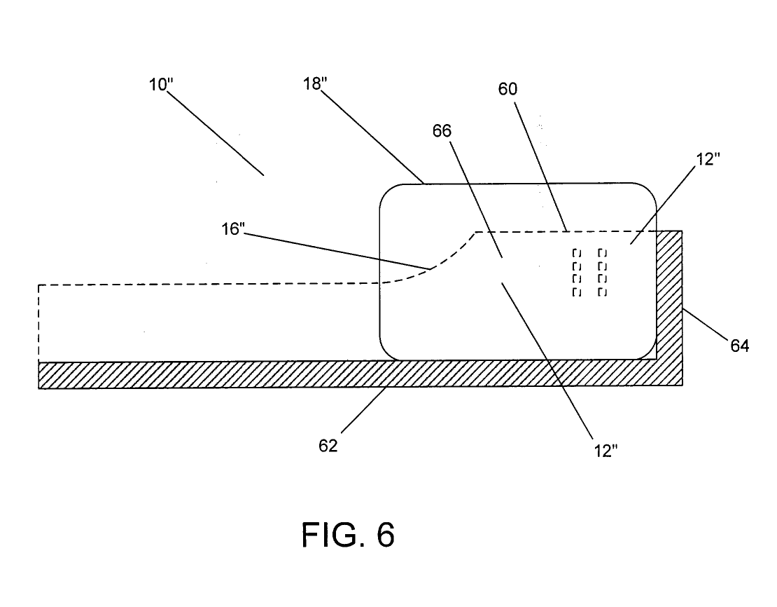

An embodiment of a card reader in accordance with the present invention that provides users with a greater ease of use is shown in FIG. 6. FIG. 6 is a cross-sectional view of a reader 10″ that includes a receiver 12″, which contains a data card 18″. The receiver is constructed so that portions of the data card protrude from the entrance 16″ to the receiver and from an opening 60 in the top of the receiver. Movement of a data card inside the receiver is prevented by the base 62, the rear wall 64 and the side walls 66 of the receiver. However, the data card can be removed from the entrance 16″ of the receiver or from the opening in the top of the receiver. Removal of the card in either of these ways is resisted by friction between the interior surface of the receiver and the data card.

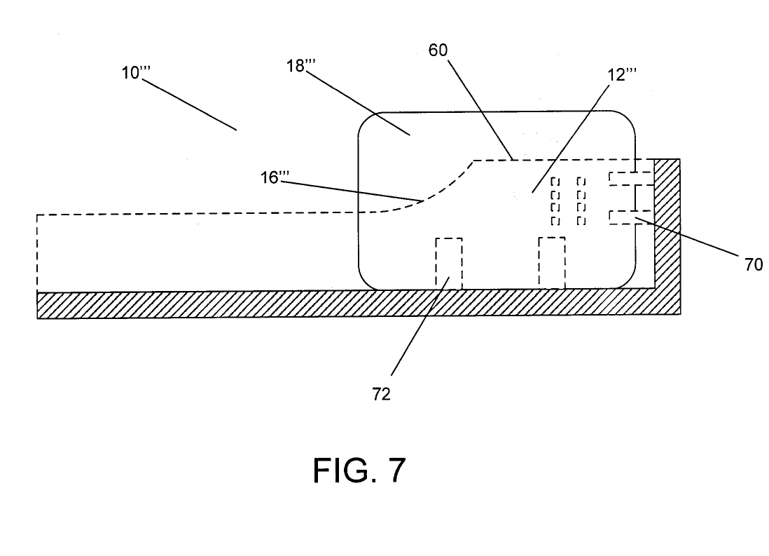

Other methods exist for preventing the removal of a data card from receivers similar to the receiver 12″ shown in FIG. 6. The use of clips to prevent the removal of a data card 18′″ from the receiver 12′″ of a reader 10′″ in accordance with the present invention is shown in FIG. 7. The receiver 12′″ contains a first set of clips 70 that resist removal of the data card from the entrance 16′″ of the receiver using the elastic properties of the clips as a spring loading to clasp the card against the interior surfaces of the receiver. The receiver also includes a second set of clips 72 that resist removal of the data card from the opening 60 in the top of the receiver by clasping the card in a similar fashion. The clips can be constructed so that the data card must be forced into the clips. Alternatively, a mechanism similar to one of the mechanisms described above can be used to mechanically or electrically engage the clips in response to the data card being inserted into the receiver.

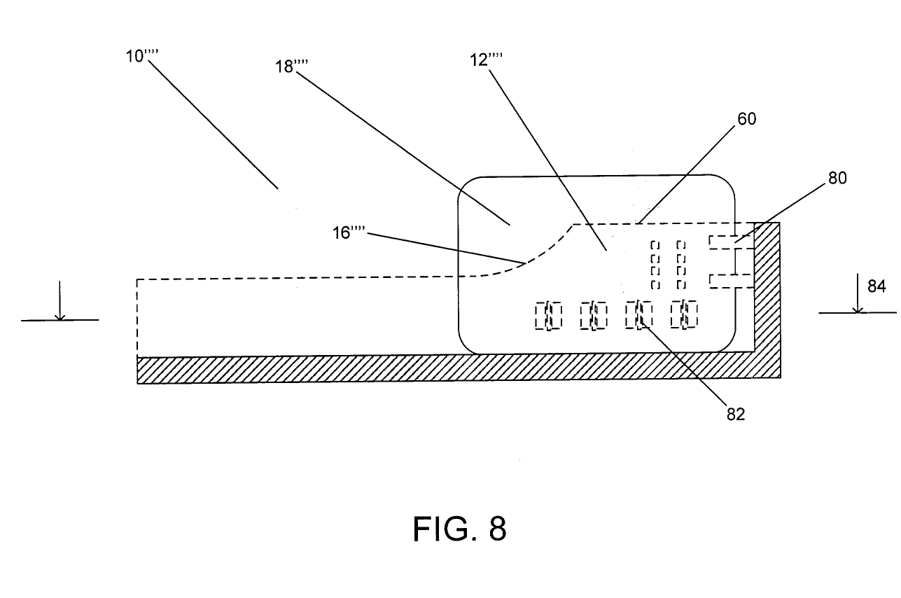

The use of rollers in combination with clips to resist movement of a data card is illustrated in FIG. 8. A cross-sectional view of a card reader 10″″, which has a data card inserted into its receiver 12″″, is shown. The receiver includes a pair of clips 80. Once a data card has been forced into the clips, the clips resist removal of the data card from the entrance 18″″ of the receiver. The receiver also includes a set of rollers 82. The rollers rotate and provide very little resistance to a data card being inserted or removed from the receiver. However, friction between the rollers and the card provides resistance to attempts to remove the card out of the opening 60 in the top of the receiver.

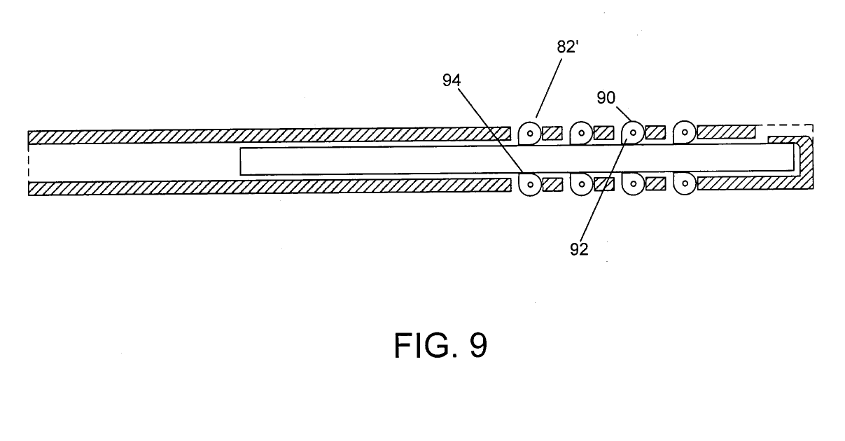

The card reader embodiment shown in FIG. 8 can be modified to include rollers formed to increase the surface area of the roller in contact with a card, when it is inserted into the receiver. The increased surface area increases the magnitude of the frictional force that resists removal of the data card out the opening at the top of the receiver. FIG. 9 is a cross-section taken along the line 84 of FIG. 8 of an embodiment of the card reader of FIG. 8 that includes non-axisymmetrical rollers. The card reader 10″″ includes rollers ₈₂′ that are non-axisymmetrical having a circular portion 90 and an elliptical portion 92. Each roller is calibrated so that the card initially contacts the circular portion causing the roller to rotate until the card is completely inserted into the receiver at which point, the elliptical portion comes into contact with the card and cams inwardly against the card which results in the card being pinched between the pairs of rollers. Once the elliptical portion is in contact with the card, the elongated edge 92 of the elliptical portion sits flush with the card creating a larger contact surface area than if the roller were completely circular. The increased contact surface creates increased friction between the rollers and the card and acts to resist attempts to remove the card out of the opening in the top of the receiver in addition to the resistance created by the camming effect of the rollers. In many embodiments, the outside surfaces of the rollers are constructed from materials having a high coefficient of friction to increase the friction forces between cards and the surfaces of the rollers.

Another technique that can be used to prevent movement of a data card within a receiver during communication between the card and a reader is to completely immobilize the card. Immobilizing a data card once it is inside the receiver ensures that the card will not be removed while the reader is communicating with the card. Card readers configured to immobilize a data card inside a receiver are discussed below.

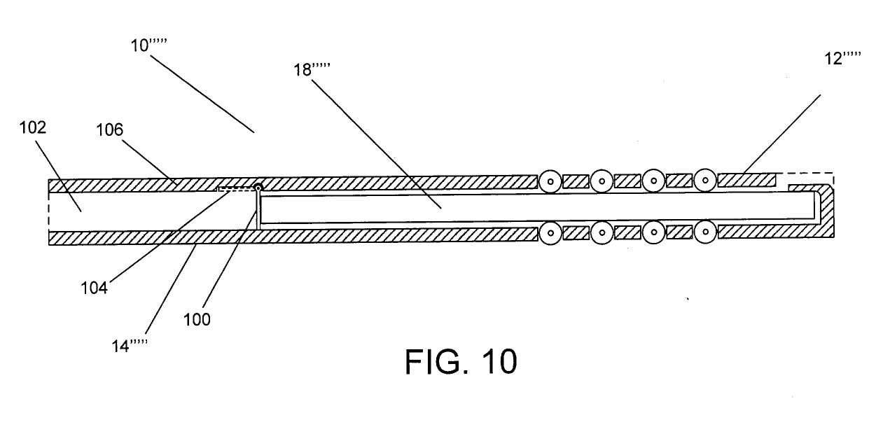

A card reader in accordance with an embodiment of the present invention that utilizes latches to immobilize data cards once they have been fully inserted into the reader receiver similar to the cross section of FIG. 9 is shown in FIG. 10. The reader 10′″″ includes at least one moveable latch 100 that can be mounted within the guiding walls or the base of the reader. The moveable latch can move from a first position, where a data card 18′″″ can be freely inserted or removed from the entrance to the receiver, to a second position, where data cards are prevented from being inserted or removed from the entrance to the receiver. In the embodiment shown, the latch is in the second position described above and can be pivotably rotated into the first position described above, where the latch rests in an alcove 104 within the guiding wall. The latch can be spring loaded and move in response to the triggering of a sensor inside the receiver or be electromechanically driven using an inductive coil, electric motor or similar device.

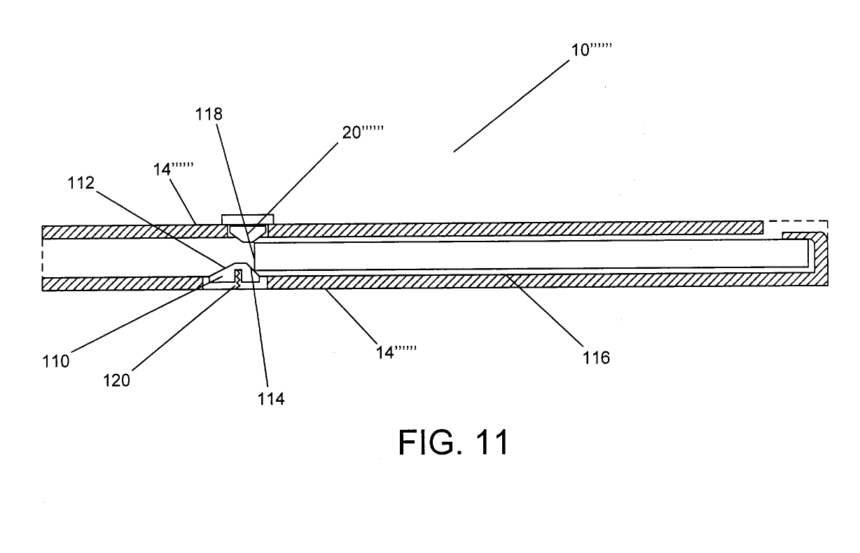

A cross section of a card reader similar to that shown in FIG. 4 with a spring loaded latch 110 is shown in FIG. 11. The cross section is taken along the line 49 in FIG. 4 and shows a spring loaded latch and a magnetic reading head 20″″″ mounted to the card guiding walls 14″″″ of the card reader. In one embodiment, the spring loaded latch has a low gradient face 112 and a high gradient face 114. As a card is pushed into the card reader, the guiding walls cause the card to encounter the low gradient face 112 of the spring loaded latch and the leading edge of the card forces the latch into the receiver enabling the card to be inserted into the card reader. The spring loaded latch is typically located to ensure that, when a card 116 is inside the card reader, the high gradient face 114 of the latch contacts the edge 118 of the card. The high gradient of this face prevents the card from being removed from the card reader unless a significant force is applied. The high gradient directs the majority of any force applied to the latch by the edge of a card in a direction perpendicular to the direction required to compress the spring 120. Consequently, a significant force is required to compress the spring, release the latch and allow the card to be removed from the card reader. Differences in the gradients of the faces of the spring loaded latch can control the difference in the forces required to insert a card into the card reader and to remove a card from the card reader. In one embodiment, the gradients of the faces are the same and in other embodiments objects with faces of uneven gradient such as a ball bearing can be used to construct the latch.

In one embodiment, the spring loading on the latch forces the card against the magnetic reading head, which is mounted on the guiding wall opposite the latch. In this embodiment, the magnetic reading head is mounted so that a card entering the card reader encounters the spring loaded latch prior to encountering the magnetic reading head. This configuration can prevent misreads of the magnetic stripe that could result from a significant change in the velocity of the card while its magnetic data is being read due to the leading edge of the card encountering the spring loaded latch.

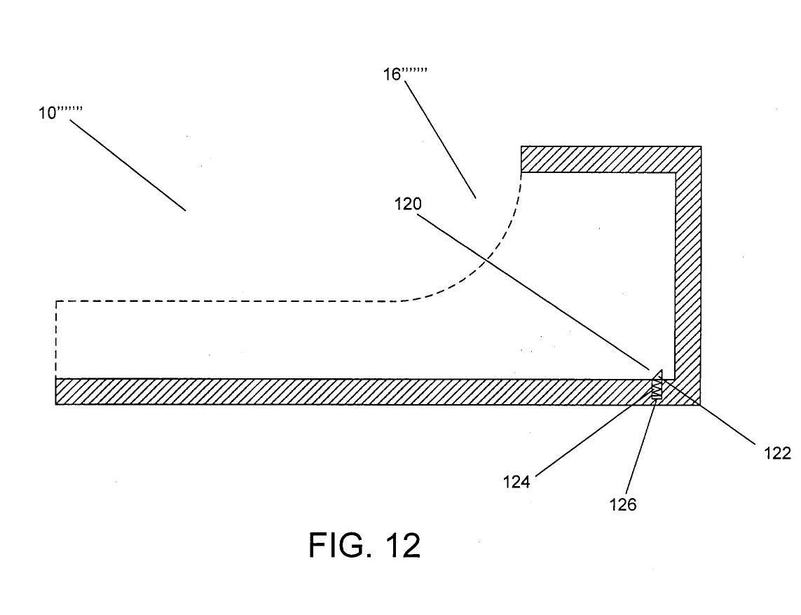

An embodiment of a card reader similar to the card reader illustrated in FIG. 4 is illustrated in FIG. 12. The card reader 10′″″″ includes a sensor 120. The sensor is configured to enable the card reader to detect small movements of a card once it has been inserted into the receiver 16′″″″. Detecting card movement enables the card reader to perform shut down routines prior to the card being removed from the receiver. In the illustrated embodiment, the sensor includes a spring loaded wedge 122, a spring 124 and a load cell 126. The wedge is forced downwards when the card is completely inserted into the receiver. This downward force compresses the spring and generates a signal in the load cell. If the card is removed, the spring decompresses and the signal emanating from the load cell is altered. This alteration can be used to detect the removal of a card and initiate shutdown procedures. In other embodiments, different types of sensors can be used including latches, optical sensors or other sensors configurable to detect the presence or absence of an object. In one embodiment, the sensor is positioned to detect movements of a card once it is inside the reader in excess of 50 mils. Preferably, card readers in accordance with the present invention can detect movements in excess of 20 mils and more preferably movements in excess of 10 mils.

While the above description contains many specific embodiments of the invention, these should not be construed as limitations on the scope of the invention, but rather as an example of one embodiment thereof. The various techniques described above for resisting or preventing motion of a data card inside the receiver of a data card reader or sensing movement of a data card can be used in any combination and other structures that achieve the same functions of resisting or immobilizing a data card or sensing movement of a data card can also be used. Accordingly, the scope of the invention should be determined not by the embodiments illustrated, but by the appended claims and their equivalents.

What is claimed is:

1. A data card reader for reading data from a data card possessing an integrated circuit and/or a magnetic stripe, comprising:
guiding walls leading to a receiver having an interior surface;
a magnetic reading head mounted on one of the guiding walls; and
electrical contacts located on the interior surface of the receiver;
wherein the receiver is configured to resist the removal of said data card when the data card is located within the receiver.

2. The data card reader of claim 1, wherein:
the receiver comprises a base, a rear wall and side walls; and
the side walls are configured to provide an entrance to the receiver.

3. The data card reader of claim 2, wherein:
the receiver further comprises a top wall; and
the base, rear wall, side walls and top wall are configured to prevent all motion of said data card except removal of the data card from the receiver entrance.

4. The data card reader of claim 2, wherein the receiver further comprises a pivotally mounted arm that is configured to resist removal of the data card from the receiver entrance.

5. The data card reader of claim 2, wherein the receiver further comprises at least one clip that is configured to resist removal of the data card from the receiver entrance.

6. The data card reader of claim 2, wherein:
the interior surface of the receiver is configured to contact the surface of the data card when the data card is within the receiver; and
friction between the interior surface and the data card resists removal of the data card from the receiver entrance.

7. The data card reader of claim 6, wherein the interior surface of the receiver contains compressible features.

8. The data card reader of claim 2, further comprising a movable latch, where the latch is configured to allow insertion of the data card when the latch occupies a first position and to resist removal of the data card when the latch occupies a second position.

9. The data card reader of claim 8, wherein the latch is spring loaded.

10. The data card reader of claim 2, wherein the side walls are also configured to form an opening in the top of the receiver.

11. The data card reader of claim 10, wherein the receiver further comprises at least one clip that is configured to resist removal of the data card from the opening in the top of the receiver.

12. The data card reader of claim 10, wherein:
the interior surface of the receiver is configured to contact the surface of the data card, when the data card is within the receiver; and
friction between the interior surface and the data card resists removal of the data card from the opening in the top of the receiver.

13. The data card reader of claim 10, further comprising:
rollers mounted in the side walls of the receiver;
wherein the rollers are configured to rotate as the data card is inserted into the receiver through the receiver entrance; and
wherein friction between the surface of the rollers and the data card resists removal of the data card from the opening in the top of the receiver.

14. The data card reader of claim 2, wherein:
the side walls and guiding walls form a curved transition at the receiver entrance;
the curved transition being configured to reduce the likelihood of an edge of the data card catching against one of the side walls of the receiver during insertion of the data card into the receiver.

15. The data card reader of claim 2, wherein the side walls flare outwards at the entrance to the receiver.

16. The data card reader of claim 2, further comprising a sensor configured to detect movement of a card inserted into the receiver.

17. The data card reader of claim 16, wherein the sensor is configured to detect movement in excess of 50 mils.

18. The data card reader of claim 16, wherein the sensor is configured to detect movement in excess of 20 mils.

19. The data card reader of claim 16, wherein the sensor is configured to detect movement in excess of 10 mils.

20. A data card reader, comprising:
a magnetic reading head mounted on a guiding wall;
a receiver connected to the guiding wall that contains electrical contacts configured to communicate with an integrated circuit located on a data card; and
wherein the receiver is configured to resist all motion of the data card when the electrical contacts communicate with the integrated circuit located on the data card.

21. A data card reader for reading data from magnetic stripes located on data cards and from integrated circuits located on data cards, comprising:
means for guiding the magnetic stripe on the data card past a magnetic reading head; and
means for resisting movement of the data card in all directions during the reading of data from the integrated circuit located on the data card.

22. A method of reading data from a data card including a magnetic stripe and/or an integrated circuit having a set of contacts, comprising the steps of:
moving the magnetic stripe relative to a magnetic reading head;
applying forces to the card that resist motion of the card; and
reading data from the card while the forces that resist motion of the card are applied to the card.
